(19) United States
(12) Patent Application Publication
(10) Pub. No.: US 2020/0048741 A1
(43) Pub. Date: Feb. 13, 2020

(54) USE OF A NICKEL-CHROMIUM-MOLYBDENUM ALLOY

(71) Applicant: VDM Metals International GmbH, Werdohl (DE)

(72) Inventors: Martin WOLF, Dortmund (DE); Rainer BEHRENS, Iserlohn (DE)

(73) Assignee: VDM Metals International GmbH, Werdohl (DE)

(21) Appl. No.: 16/342,675

(22) PCT Filed: Dec. 12, 2017
(86) PCT No.: PCT/DE2017/101066

§ 371 Date: Apr. 17, 2019

(30) Foreign Application Priority Data
Dec. 16, 2016 (DE) 10 2016 124 588.7

(51) Int. Cl. C22C 19/05; C22F 1/10

(52) U.S. Cl. CPC C22C 19/055; B23K 2103/18; C22F 1/10

(57) ABSTRACT

The invention relates to the use of an alloy having the composition (in mass %) of: Cr 20.0 to 23.0%, Mo 18.5 to 21.05%, Fe≤1.5%, Mn≤0.5%, Si≤0.1%, Co≤0.3%, W≤0.3%, Cu≤0.5%, Al≤0.4%, C≤0.01%, P≤0.015%, S≤0.01%, N 0.02 to 0.15%, if necessary V≤0.3%, Nb≤0.2%, Ti≤0.02%, the rest Ni and further smelting-related impurities as cladding material in the field of thermal reprocessing systems and substitute-material combustion systems.

The invention relates to the use, for the coating of steels, of a nitrogen-alloyed nickel-chromium-molybdenum alloy, which has a high corrosion resistance to aggressive media that may be formed during thermal reprocessing.

WO 98/55661 discloses a kneadable homogeneous austenitic nickel alloy having a high corrosion resistance to aggressive liquid media, both under oxidizing and reducing conditions, and an excellent resistance to local corrosion in acid, chloride-containing media. The alloy consists of (mass %) chromium 20.0 to 23.0%, molybdenum 18.5 to 21.0%, iron max. 1.5%, manganese max. 0.5%, silicon max. 0.1%, cobalt max. 0.3%, tungsten max. 0.3%, copper max. 0.3%, aluminum 0.1 to 0.3%, magnesium 0.001 to 0.15%, calcium 0.001 to 0.01%, carbon max. 0.01%, nitrogen 0.05 to 0.15%, vanadium 0.1 to 0.3%, the rest nickel and further smelting-related impurities. The alloy is suitable as a material for structural parts that must be resistant to chemical attack and as overalloyed weld filler for other nickel-base materials.

At present, nickel alloys such as FM 625, FM 622 and FM 686, for example, are used as cladding materials in the application for the thermal reprocessing such as in waste incineration systems, substitute-material combustion systems or biomass systems, for example. Although heat-exchanger tubes, heating surfaces as well as surfaces and other structural parts contacted by flue gas are frequently protected against corrosion by cladding, erosions—depending on the material and operating conditions used—occur at the superheater tubes and other thermally stressed structural parts, forcing shutdowns and cost-intensive maintenance tasks upon the operator.

The objective of the invention is to provide the alloy that has been used for years according to the prior art with a new area of application in the field of cladding.

This objective is accomplished by the use of an alloy having the composition (in mass %) of

Cr 20.0-23.0%

Mo 18.5-21.05%

Fe≤1.5%

Mn≤0.5%

Si≤0.1%

Co≤0.3%

W≤0.3%

Cu≤0.5%

Al≤0.4%

C≤0.01%

P≤0.015%

S≤0.01%

N 0.03-0.15%

if necessary

V≤0.3%

Nb≤0.2%

Ti≤0.02%

Ni the rest as well as smelting-related impurities

as cladding material in the field of thermal reprocessing systems and substitute-material combustion systems.

Advantageous further developments of the subject matter of the invention can be inferred from the dependent claims.

During investigations of the above-mentioned material, which heretofore has been used exclusively in the wet-corrosion field, it has been surprisingly observed that it can also be used advantageously in the temperature range of thermal reprocessing.

Preferred chemical compositions (in mass %) are listed in the following:

Cr>20.0-<23.0%

Mo>18.5-<21.0%

Fe>0.1-<1.0%

Mn>0.05-<0.4%

Si>0.05-<0.10%

Co≤0.2%

W≤0.25%

Cu≤0.4%

Al≤0.3%

C≤0.05%

P≤0.015%

S≤0.005%

N 0.04-<0.10%

if necessary

V≤0.25%

Nb≤0.2%

Ti≤0.02%

Ni the rest as well as smelting-related impurities

Corrosion stresses in structural parts and surfaces of thermal reprocessing systems contacted with flue gas are diverse and complex. Thus diverse types of (diffusion-controlled) high-temperature corrosion occur, such as corrosion due to carbonization, molten salts or corrosion due to halogens (especially chlorine). Beyond this, the materials used may be additionally severely stressed by wet-corrosion mechanisms during shutdown and maintenance periods.

It has been found that the material known in itself is outstandingly suitable for being used as a cladding material in the field of a thermal reprocessing system. In several investigations, it has been demonstrated that this material has excellent weldability (high crack resistance and good wettability) with respect to the method of weld-cladding. The application of the cladding layers may be carried out not only by deposition welding but also, for example, by flame or plasma spraying by means of powder or wire.

In the “green death” test solution, the critical pitting corrosion temperature starting from the second deposit-welding pass is approximately 135° C. Thus intensified pitting-corrosion attacks due to pitting corrosion seem somewhat improbable during shutdown and maintenance periods.

Furthermore, it has been found that the pure weld metal in the operationally stressed condition has a surprisingly high offset yield strength RP0.2 of at least 600 MPa. In addition, it has also been possible to note that an increase of the hardness takes place, as shown in Table 1, due to the operating stress. In addition to the high chromium and molybdenum content of the alloy and the mechanism of solution strengthening, a further hardness increase takes place in the operating condition due to the precipitation of intermetallic phases.

With these experimental results, it is to be expected that, under the harsh conditions of a thermal reprocessing system, where not only the purely diffusion-controlled/electrochemical corrosion plays a role, but in particular so also does the combination with the resistance of a material to mechanical stress, e.g. due to scattered and smoke particles (erosion and erosion-corrosion), this material has a new kind of property profile.

The invention will be explained in more detail in the following on the basis of an example:

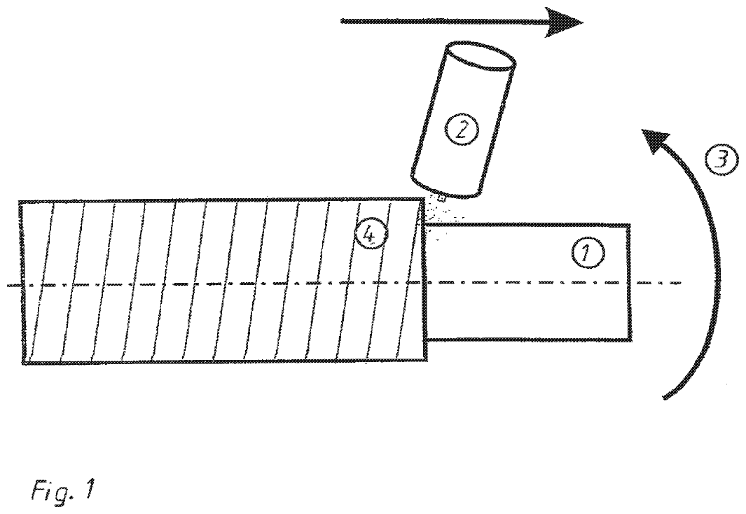

FIG. 1 shows, as an example, a heat-exchanger tube 1, which may be used in a waste incineration system (not illustrated). In this example, tube 1 is supposed to be a water-cooled structural part of a carbon steel. By means of a welding torch 2 (e.g. MIG or TIG), which is merely indicated, a deposition-welding material 4 is applied with rotation 3 of the tube 1.

In Table 1, the compositions of the deposition-welding material according to the invention are listed on the one hand as are those of alternative materials that have found use heretofore.

TABLE 1

| | Material | | |
|---|---|---|---|
| | FM 2120 | FM 625 | FM 622 |
| | Batch no. | | |
| | 115544*) | 115949 | 122001 |
| C | 0.003 | 0.015 | 0.005 |
| S | 0.002 | 0.002 | 0.004 |
| N | 0.068 | 0.018 | 0.016 |
| Cr | 20.7 | 22.3 | 21.4 |
| Ni | 59.2 (rest) | 64.3 (rest) | 59.2 (rest) |
| Mn | 0.13 | 0.01 | 0.16 |
| Si | 0.04 | 0.07 | 0.03 |
| Mo | 18.83 | 9.21 | 13.7 |
| Fe | 0.52 | 0.20 | 2.2 |
| Al | 0.19 | 0.06 | 0.11 |
| B | 0.002 | <0.001 | 0.001 |
| V | 0.15 | <0.01 | 0.17 |
| W | 0.10 | 0.02 | 2.87 |

*)Smelting-related impurities: Co, Cu, P, Nb, Ti

Material data, in the welded condition, are listed in Table 2 for the materials listed in Table 1.

TABLE 2

| | FM 2120 | FM 625 | FM 622 |
|---|---|---|---|
| Rp 0.2 (MPa) | 648 | 519 | 512 |
| Rm (MPa) | 841 | 768 | 746 |
| A5 (%) | 40 | 41 | 46 |
| KV (RT, J) | 33 | 164 | 148 |
| Corrosion | ISO 3651-2 | SEP 1877 II | SEP 1877 II |
| resistance | no corrosion | no corrosion | no corrosion |

TABLE 3
Comparison of the HV0.1 values of deposition-welding metals in
the starting condition (as welded) and in the aged condition.

| | Distance | Sample 1 | Sample 2 | Sample 3 |
|---|---|---|---|---|
| | from the | (1 pass) | (2 passes) | (3 passes) |
| Condition | surface in mm | HV 0.1 | HV 0.1 | HV 0.1 |
| Starting | 1.0 | 215 | 273 | 280 |
| condition | | | | |
| Aged (1000 | 1.0 | 331 | 342 | 462 |
| hours at | | | | |
| 620° C.) | | | | |

The material FM 2120, which can be used for structural parts in waste incineration systems, is distinguished from the comparison materials by higher strength values RP 0.2 as well as Rm. Subsequent calculations with Calphad software have shown that this effect is caused by, among other factors, the formation of intermetallic phases, such as the p-phase, for example. This can also be proved by metallographic examinations.

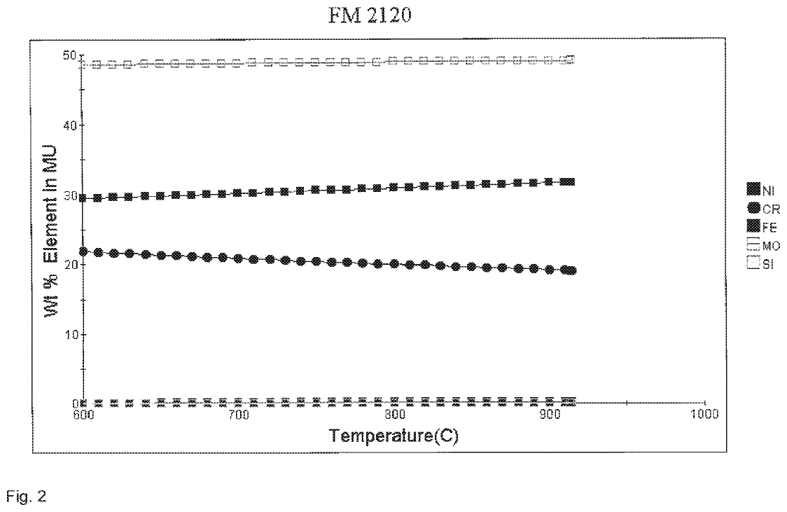

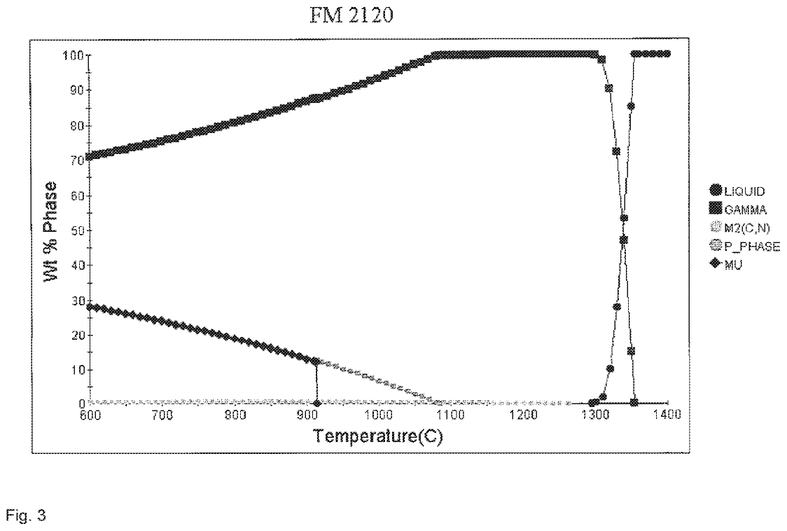

The calculation of the phase diagram shows the presence of the intermetallic μ-phase (FIG. 2) for the thermodynamic equilibrium condition in the temperature range below 920° C. At 650° C., the quantity of these phases is approximately 27 wt % (FIG. 3) and it leads to the change of the mechanically technological properties and microstructural adjustment of the cladding material. The said p-phase is formed by the longer-lasting heat influence in the temperature range in the existence range of this phase in the cladding material.

1: Use of an alloy having the composition (in mass %) of
Cr 20.0-23.0%
Mo 18.5-21.05%
Fe≤1.5%
Mn≤0.5%
Si≤0.1%
Co≤0.3%
W≤0.3%
Cu≤0.5%
Al≤0.4%
C≤0.01%
P≤0.015%
S≤0.01%
N 0.02-0.15%
if necessary
V≤0.3%
Nb≤0.2%
Ti≤0.02%
Ni the rest as well as smelting-related impurities
as cladding material in the field of thermal reprocessing systems and substitute-material combustion systems.

2: Use according to claim 1 with the following composition (in mass %):
Cr>20.0-<23.0%
Mo>18.5-<21.0%
Fe>0.1-<1.0%
Mn>0.05-<0.4%
Si>0.001-<0.10%
Co≤0.2%
W≤0.25%
Cu≤0.4%
Al≤0.3%
C≤0.05%
P≤0.015%
S≤0.005%
N 0.04-<0.1%
if necessary
V≤0.25%
Nb≤0.2%
Ti≤0.02%
Ni the rest as well as smelting-related impurities.

3: Use according to claim 1, wherein the cladding material is used in the field of heat-exchanger tubes of the waste incineration system.

4: Use according to claim 1, wherein the cladding material after application has an offset yield strength Rp 0.2 of at least 600 MPa in the operationally stressed condition.

5: Use according to claim 1, wherein the cladding material, as a deposition-welding material, has an offset yield strength Rp 0.2 (MPa) above 600, especially above 640.

6: Use according to claim 1, wherein the cladding material, as a deposition-welding material, has a tensile strength Rm (MPa) above 800, especially above 840.

7: Use according to claim 1, wherein the cladding material is used for repairs.
